(19) United States
(12) Patent Application Publication
(10) Pub. No.: US 2020/0190730 A1
(43) Pub. Date: Jun. 18, 2020

(54) STRUCTURE MADE WITH MULTILAYER FABRIC INFUSED WITH RESIN AND METHOD FOR MANUFACTURING THEREOF

(71) Applicant: VisionKnit Limited, Toronto (CA)

(72) Inventors: Andrew Mullins, Toronto (CA); Andy Phillips, Toronto (CA); Juergen Garus, Toronto (CA); Jenny Toth, Toronto (CA)

(73) Assignee: VisionKnit Limited, Toronto (CA)

(21) Appl. No.: 16/714,186

(22) Filed: Dec. 13, 2019

Related U.S. Application Data
(60) Provisional application No. 62/779,078, filed on Dec. 13, 2018.

(51) Int. Cl. D06M 17/04; D04B 7/04; D04B 1/22; D04B 1/12; D04B 1/16; D04B 21/08; D04B 23/04; B32B 5/02; B32B 5/26; B63B 5/00

(52) U.S. Cl. CPC D06M 17/04; D04B 7/04; D04B 1/22; D04B 1/12; D04B 1/16; D04B 21/08; D06M 2101/32; B32B 5/026; B32B 5/26; B63B 5/00; D10B 2331/04; D10B 2331/02; D04B 23/04

(57) ABSTRACT

A structure, comprising a multilayer fabric infused by a resin, is disclosed. There is also provided a method for manufacturing a structure, comprising, laying a multilayer fabric over a mold of the structure; and infusing a resin into the multilayer fabric. The structure can be, by way of example only, a canoe, a wind fairing, a panel for use as wall decoration, a cover of a body of a vehicle, a corn hole game surface or a pickle ball paddle face.

### CROSS-REFERENCE TO RELATED APPLICATIONS

This application claims the benefit of U.S. provisional patent application Ser. No. 62/779,078, filed Dec. 13, 2018.

### STATEMENT REGARDING FEDERALLY SPONSORED RESEARCH OR DEVELOPMENT

Not applicable.

### TECHNICAL FIELD

The present application generally relates to a structure, in particular to a structure made with a multilayer fabric infused with resin and to a method of manufacturing the structure.

### BACKGROUND OF THE INVENTION

It is well known to produce a structure, such as a canoe, by hand layering materials such as fiberglass on a mold and then applying resin through techniques, such as hand layup, vacuum infusion, or resin transfer molding. The process of hand layering materials on a mold to make a structure is quite laborious. As well, the fiberglass shell of the canoe is typically painted and can be decaled, both of which are susceptible to wear. As well, conventional layup techniques for canoes tend to waste lots of materials such as fiberglass, as material is cut and discarded to match the profile of the mold.

### SUMMARY OF THE INVENTION

According to an aspect, there is provided a structure, comprising a multilayer fabric infused by a resin.

According to another aspect, there is provided a method for manufacturing a structure, comprising: laying a multilayer fabric over a mold of the structure; and infusing a resin into the multilayer fabric.

According to another aspect, the structure can be, for example, a canoe, a wind fairing, a panel for use as wall decoration, a cover of a body of a vehicle, a corn hole game surface or a pickle ball paddle face.

Advantages and features of the invention will become apparent upon review of the detailed description and claims with reference to the appended drawings, the latter being briefly described hereinafter.

### BRIEF DESCRIPTION OF THE DRAWINGS

FIG. 1 is a photo showing a first side of a fabric according to an embodiment of the present disclosure;

FIG. 2 is an enlarged view of a portion of the first side of the fabric in FIG. 1;

FIG. 3 is an enlarged view of the layers of a portion of the fabric in FIG. 1;

FIG. 4 is a photo showing a second side of the fabric in FIG. 1;

FIG. 5 is an enlarged view of a portion of the fabric in FIG. 4;

FIG. 6A is an example of a panel made from a multilayer fabric;

FIG. 6B is an example of a shaped multilayer fabric;

FIG. 7A is a schematic view showing a Milano rib stitch that can be used in the practice of the invention;

FIG. 7B is a schematic view showing a cross tubular stitch with a Poly-paraphenylene terephthalamide floating stitch that can be used in the practice of the invention;

FIG. 7C is a schematic view showing a cross tubular stitch that can be used in the practice of the invention; and

FIG. 7D is a schematic view showing a 4-color bird's eye stitch that can be used in the practice of the invention.

### DESCRIPTION OF EXAMPLE EMBODIMENTS

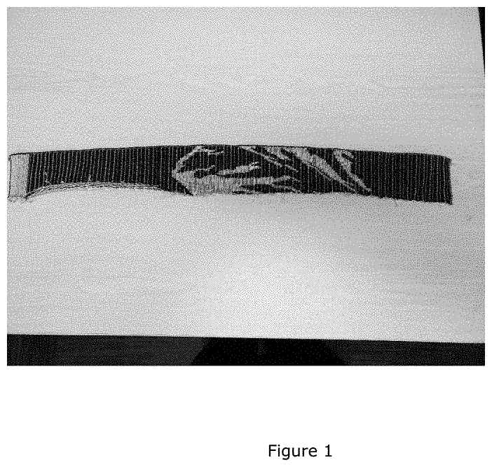

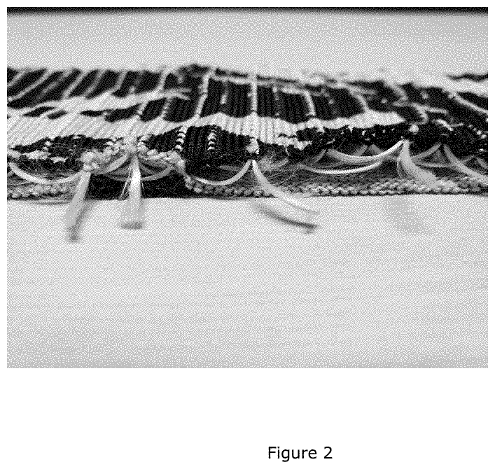

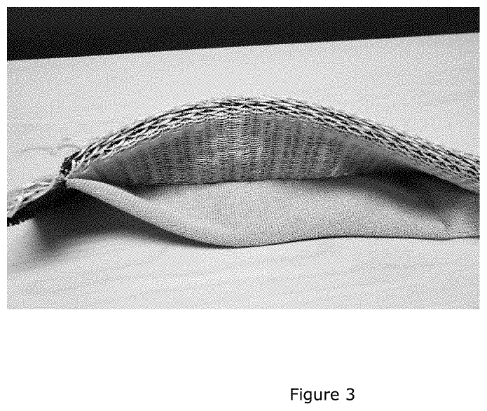

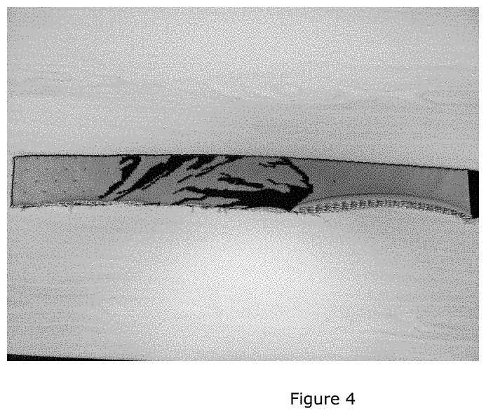

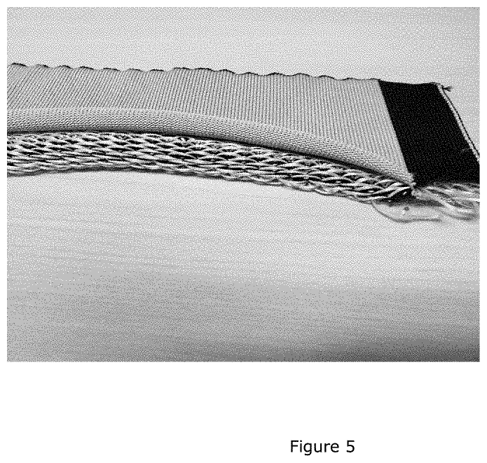

The present application discloses a structure made with a piece of multilayer fabric infused with resin. The structure may be a canoe, a wind faring, or any object that has a fixed shape. FIGS. 1-5 and 6B show examples of a fabric that may be used to make the structure.

The fabric in the example of FIGS. 1-5 and 6B includes two layers of fabric knitted together. The fabric may be knitted with at least two needle beds on a knitting machine. The knitting machine may be a flat bed or circular bed knitting machine. The needle bed of a knitting machine is made up by needles. A knitting machine may have one, two or more needle-beds. A flat knitting machine may manufacture bi-layer and multilayer knit fabrics.

In an example, a knitting machine with two needle beds knits and purls stitches in a single row. The knitting machine can pattern on both beds. The knitting machine can produce knitted fabric which has been shaped to the desired dimensions that can be cut and sewn with traditional sewing techniques and patterns.

Each needle bed may create a layer of a fabric. Multiple needle beds create multiple layers of the fabric. All of the layers of the fabric may be knitted together to create a piece of the fabric. The thickness of the structure is determined by the number of layers of the fabric, and the thickness of each layer. The multiple layers of the fabric have the desired thickness of the structure. The thickness of each layer is determined by the dimension of the yarn used to knit the layer.

Patterns may also be kitted in one or more layers of the fabric. By using multiple needle beds of a flatbed knitting machine, a pattern, including a graphical pattern, may be created at a desired location in one or more of the multiple layers of the fabric.

In some examples, the pattern is on the same position on each layer. The pattern of the fabric may be formed of the colored yarn, or yarn that has a different color from the yarn surrounding the pattern, to distinguish the pattern from the surrounding portion of a layer of the fabric. In some examples, polyester filament yarns, which are relatively inexpensive, may be used for creating the pattern.

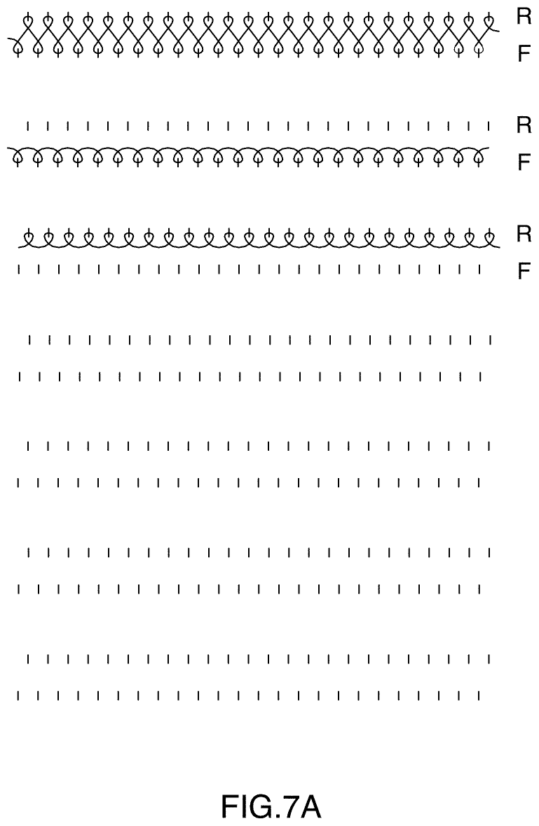

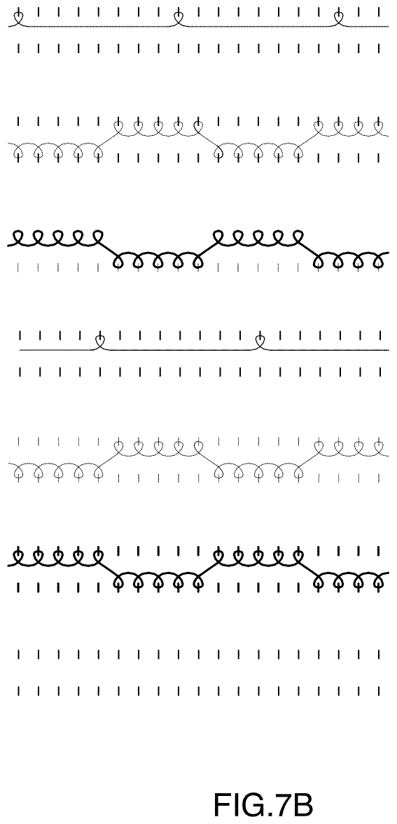

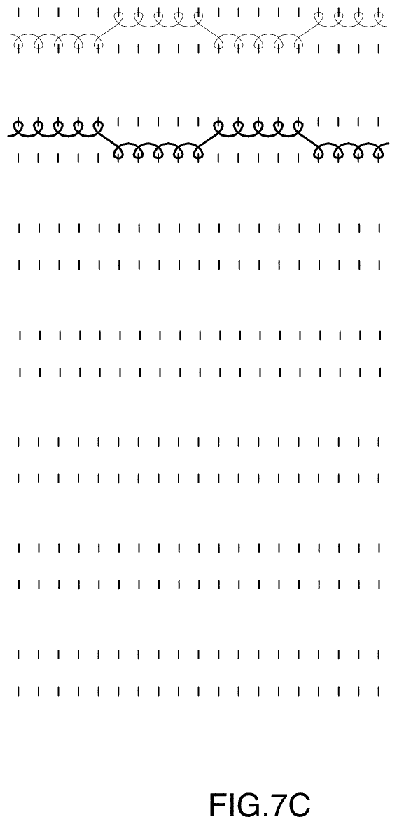

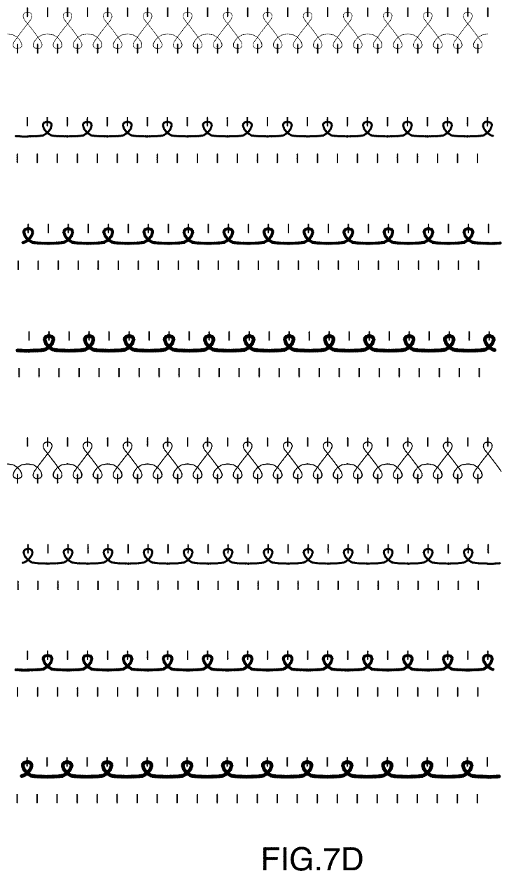

In some examples, reinforcement fibers may be used in knitting a layer of fabric for reinforcing the strength of the layer. For example, the reinforcement fibers may be selected from aramid, by way of example and not limitation, poly-paraphenylene terephthalamide (KEVLAR™, DuPont, Del., USA) and p-phenylene terephthalamide (TWARON™, Teijin Aramid B.V. Netherlands), graphene, carbon and fiberglass, ceramic fibers, etc. Various types of knit patterns can be utilized to knit a layer of the fabric, including jacquards, and more specifically including cross tubular, as shown in FIG. 7A, birds-eye as shown in FIG. 7B and Milano rib structures. Jacquard describes a repeating pattern of a knitting machine in knitting. In some examples, the knit pattern is a 4 color birds-eye. In some examples, a cross tubular knit of polyester with a floating poly-paraphenylene terephthalamide stitch connected on the rear side of a reinforcement fiber may be used to knit a layer of the fabric. The poly-paraphenylene terephthalamide may float over seven needles, namely that the poly-paraphenylene terephthalamide is only connected at every seventh “knot.”

In some examples, the pattern or graphical pattern is integrated in all layers of the fabric. In some examples, one or more of the top layers of the fabric may include the pattern, and one and more bottom layers may not include the pattern. By knitting the pattern in at least one layer of the fabric, the pattern is more durable than simply painting or decaling the pattern on the surface of the layer.

The fabric knitted with multiple layers may be infused with resin to form a hard laminate structure. For example, the fabric may be first laid upon a mold for a structure. Resin may be then applied to fabric. Any conventional resin can be applied to the fabric, including polyester resin, vinyl ester resin and epoxy resin.

A resin may be applied to the fabric through techniques such as hand layup by using a roller, vacuum infusion [placing a plastic layer over the fabric and then applying a vacuum for pulling and drawing the resin through the fabric] or resin transfer molding by using a liquid thermoset resin to saturate a fiber preform placed in a closed mold. When the resin is cured, the structure becomes a hard laminate structure, and the profile of the laminate structure is substantially fixed. In some examples, if the thickness of a layer meets the requirements of a structure, the structure may also be made from a single layer fabric infused with resin to form a hard laminate structure.

The flat bed knitting machine can produce multiple layer fabric with a shape that fits exactly into the mold; therefore, the fabric may be laid on the mold as single pieces without cutting off any extra materials. In this case, using the multiple layer fabric to produce a structure reduces waste. In some examples, the fabric may be trimmed to fit into the mold. Since multiple layers are incorporated into the fabric and the layers of the fabric are all held fixedly positioned to one another, using the multiple layer fabric to produce a structure reduces layup time on a mold. As such, the molding process using a single piece of fabric is faster than hand layering multiple pieces of material. As well, by knitting the fabric in a single piece, the integrity of the overall structure can be improved over the structure formed by several pieces since the reinforcement, etc., can be accurately placed and distributed.

In some examples, the hard laminate structure may be a canoe. In the example of the present application, a single piece of multilayer fabric having a shape that fits exactly or substantially into the mold may be first laid upon a mold for a canoe. Resin may be then applied to the fabric using the techniques described above. The resin may be any conventional resin, including polyester resin, vinyl ester resin and epoxy resin. When the resin is cured, the fabric infused with resin may be taken out from the mold as a product of canoe.

In some examples, a canoe is constructed using about 5.28 kg polyester yarn, about 1.44 kg Poly-paraphenylene terephthalamide yarn and 8.74 kg polyester resin, resulting in a 16′ prospector style canoe that weighs, all-in, about 70 lbs. The weight of the canoe constructed is comparable to that of a standard fiberglass canoe. The canoe made with the fabric infused with resin is lighter than plastic canoes which can weight about 100 pounds.

In some examples, the structure made with multilayer fabric infused with resin may be a wind faring that is positioned underneath a highway trailer.

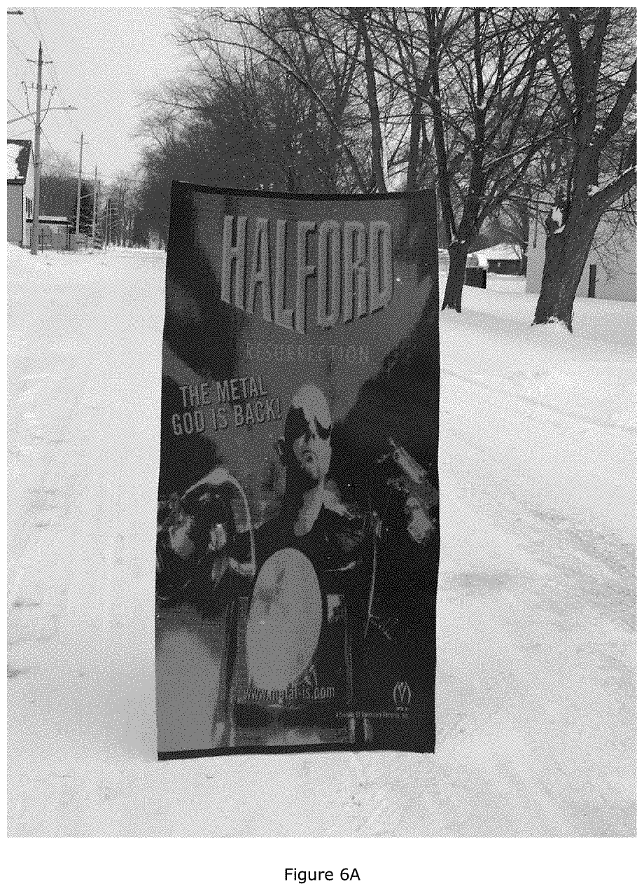

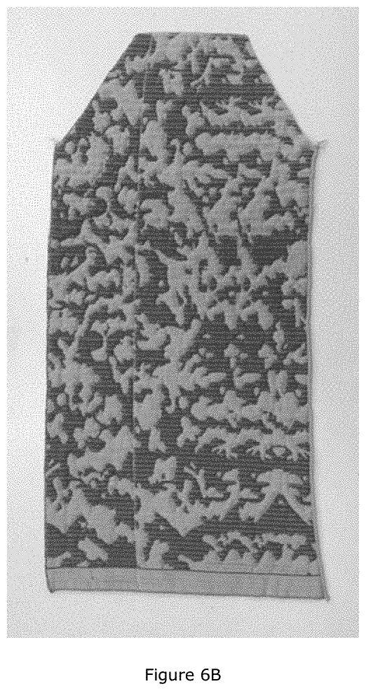

In some examples, the structure made with multilayer fabric infused with resin may be a panel. The panel may also have different shapes. The panel may be flat. For example, the structure may be a panel used for a cover of a body of a vehicle, such as a truck door, a corn hole game surface, a pickle ball paddle face, etc. As illustrated in FIG. 6A, a flat rectangular panel with multilayer fabric infused with resin may include graphics for use as a post panel, or a panel sign. As illustrated in FIG. 6B, the structure may be a panel with a graphic used for wall decoration.

Certain adaptations and modifications of the described embodiments can be made. Therefore, the above discussed embodiments are considered to be illustrative and not restrictive.

We claim:

1. A structure, comprising:
a multilayer fabric infused with a resin.

2. The structure of claim 1, wherein the multilayer fabric is created on a flatbed knitting machine having at least two needle beds.

3. The structure of claim 2, wherein the structure is a canoe.

4. The structure of claim 3, wherein the canoe is constructed using polyester yarn, Poly-paraphenylene terephthalamide yarn and polyester resin.

5. The structure of claim 1, wherein the structure is a wind fairing.

6. The structure of claim 1, wherein at least one layer of the multilayer fabric is knitted with a pattern.

7. The structure of claim 1, wherein the multilayer fabric comprises two layers.

8. The structure of claim 1, wherein the multilayer fabric comprises reinforcement fibers.

9. The structure of claim 8, wherein the reinforcement fibers comprise at least one of aramid, Poly-paraphenylene terephthalamide, graphene, carbon and fiberglass.

10. The structure of claim 1, wherein the resin comprises at least one of polyester resin, vinyl ester resin and epoxy resin.

11. The structure of claim 1, wherein the structure is a panel for use as wall decoration, a cover of a body of a vehicle, a corn hole game surface or a pickle ball paddle face, water slides, tabletops, modular fiberglass enclosures.

12. A method for manufacturing a structure, comprising:
laying a multilayer fabric over a mold of the structure; and
infusing a resin over the multilayer fabric.

13. The method of claim 11, wherein the knitted multilayer fabric is a single piece fabric.

14. The method of claim 11, wherein the multilayer fabric is knitted with at least two needle beds on a flatbed knitting machine.

15. The method of claim 13, wherein the multilayer fabric is knitted with at least one of cross tubular, birds-eye and Milano rib structures.

16. The method of claim 11, wherein the resin is applied to the multilayer fabric by at least one of hand layup, vacuum infusion and resin transfer molding.

17. The structure of claim 1, wherein the multilayer fabric is created on a flat bed or circular bed knitting machine having at least two needle beds.
